(19) United States
(12) Patent Application Publication
(10) Pub. No.: US 2021/0377813 A1
(43) Pub. Date: Dec. 2, 2021

(54) FREQUENCY REPORTING FOR TONE RESERVATION

(71) Applicant: QUALCOMM Incorporated, San Diego, CA (US)

(72) Inventors: Shay Landis, Hod Hasharon (IL); Amit Bar-Or Tillinger, Petach Tikva (IL); Gideon Shlomo Kutz, Ramat Hasharon (IL); Ory Eger, Tel Aviv (IL); Assaf Touboul, Netanya (IL)

(21) Appl. No.: 16/889,507

(22) Filed: Jun. 1, 2020

(51) Int. Cl. H04W 28/26; H04W 72/04; H04W 24/10; H04L 5/00; H04L 27/26; H04W 72/08

(52) U.S. Cl. CPC H04W 28/26; H04W 72/0453; H04W 24/10; H04W 72/085; H04L 27/2614; H04L 5/0073; H04L 5/006; H04L 5/0051

(57) ABSTRACT

Methods, systems, and devices for wireless communications are described. Generally, to improve throughput via more intentional tone reservation, a receiving device (e.g., a user equipment (UE)), may identify one or more tones that have poor signal quality. The receiving device may transmit an indication of the one or more tones having poor signal quality to a transmitting device. The transmitting device may reserve one or more of the identified tones for use in a tone reservation scheme, such as to carry peak-to-average power ratio (PAPR) reduction signals, and may transmit data signals over tones that have higher signal quality.

### FIELD OF TECHNOLOGY

The following relates generally to wireless communications and more specifically to frequency reporting for tone reservation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support frequency reporting for tone reservation. Generally, a transmitting device (e.g., a base station) may configure a transmission across a set of frequency resources (e.g., a set of subcarriers). In some examples, to reduce a peak-to-average power ratio (PAPR) and improve power efficiency, the transmitting device may reserve one or more tones (e.g., may reserve one or more resource blocks (RBs), one or more resource elements (REs), or the like) for PAPR reduction. The transmitting device may thus transmit one or more PAPR reduction signals on the reserved tones and data signals (e.g., information-carrying signals, such as control information, data, or other types of information for decoding and use by a receiving device) on the remaining tones of the set of frequency resources.

In some examples, to improve throughput for transmissions associated with a tone reservation scheme (e.g., for PAPR reduction), a receiving device (e.g., a user equipment (UE)), may identify one or more tones that have poor signal quality, based on or more metrics. The receiving device may transmit an indication of the tones having poor signal quality to the transmitting device. The transmitting device may reserve one or more of the identified tones for PAPR reduction signals, and may transmit data signals over tones that have higher signal quality.

A method of wireless communications at a UE is described. The method may include receiving, from a base station, reference signals associated with a set of candidate frequency resources for tone reservation, performing one or more signal quality measurements on the reference signals, selecting from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources, transmitting, to the base station, an indication of the selected set of frequency resources for tone reservation, and receiving, based on the indication, information from the base station via the one or more other frequency resources.

An apparatus for wireless communications at a UE is described. The apparatus may include a processor, memory coupled with the processor, and instructions stored in the memory. The instructions may be executable by the processor to cause the apparatus to receive, from a base station, reference signals associated with a set of candidate frequency resources for tone reservation, perform one or more signal quality measurements on the reference signals, select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources, transmit, to the base station, an indication of the selected set of frequency resources for tone reservation, and receive, based on the indication, information from the base station via the one or more other frequency resources.

Another apparatus for wireless communications at a UE is described. The apparatus may include means for receiving, from a base station, reference signals associated with a set of candidate frequency resources for tone reservation, performing one or more signal quality measurements on the reference signals, selecting from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources, transmitting, to the base station, an indication of the selected set of frequency resources for tone reservation, and receiving, based on the indication, information from the base station via the one or more other frequency resources.

A non-transitory computer-readable medium storing code for wireless communications at a UE is described. The code may include instructions executable by a processor to receive, from a base station, reference signals associated with a set of candidate frequency resources for tone reservation, perform one or more signal quality measurements on the reference signals, select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources, transmit, to the base station, an indication of the selected set of frequency resources for tone reservation, and receive, based on the indication, information from the base station via the one or more other frequency resources.

Some examples of the method, apparatuses, and non-transitory computer-readable medium described herein may further include operations, features, means, or instructions for receiving, based on the indication, one or more signals via the selected set of frequency resources for tone reservation, where the one or more signals may be configured to reduce a peak-to-average-power-ratio (PAPR) associated with receiving the information.

In some examples of the method, apparatuses, and non-transitory computer-readable medium described herein, the selecting may include operations, features, means, or instructions for selecting from the set of candidate frequency resources, based on the one or more signal quality measurements, a first frequency resource having a lowest signal quality, where the selected set of frequency resources includes the first frequency resource.

In some examples of the method, apparatuses, and non-transitory computer-readable medium described herein, the selecting further may include operations, features, means, or instructions for selecting from the set of candidate frequency resources, based on the one or more signal quality measurements, one or more additional frequency resources in ascending order of signal quality relative to the first frequency resource until a target quantity of frequency resources may be selected, where the selected set of frequency resources further includes the one or more additional frequency resources.

In some examples of the method, apparatuses, and non-transitory computer-readable medium described herein, the selecting may include operations, features, means, or instructions for identifying within the set of candidate frequency resources, based on the one or more signal quality measurements, a group of frequency resources that each satisfy a threshold signal quality, and selecting from the group of frequency resources, based on the one or more signal quality measurements, a first frequency resource having a lowest signal quality, where the selected set of frequency resources includes the first frequency resource.

In some examples of the method, apparatuses, and non-transitory computer-readable medium described herein, the selecting further may include operations, features, means, or instructions for selecting from the group of frequency resources, based on the one or more signal quality measurements, one or more additional frequency resources in ascending order of signal quality relative to the first frequency resource until a target quantity of frequency resources may be selected, where the selected set of frequency resources further includes the one or more additional frequency resources.

In some examples of the method, apparatuses, and non-transitory computer-readable medium described herein, transmitting the indication of the selected set of frequency resources for tone reservation may include operations, features, means, or instructions for transmitting a channel state information report including the indication, the channel state information report further indicating the one or more other frequency resources.

Some examples of the method, apparatuses, and non-transitory computer-readable medium described herein may further include operations, features, means, or instructions for transmitting a channel state information report that indicates the one or more other frequency resources, where the indication of the selected set of frequency resources for tone reservation may be transmitted apart from the channel state information report.

Some examples of the method, apparatuses, and non-transitory computer-readable medium described herein may further include operations, features, means, or instructions for determining for a frequency resource within the set of candidate frequency resources, based on the one or more signal quality measurements, a level of interference, an amount of channel fading, a received signal power, an extent of harmonic distortion, or any combination thereof, where the selecting may be based on the determining.

In some examples of the method, apparatuses, and non-transitory computer-readable medium described herein, the set of candidate frequency resources includes a set of resource blocks, and where the selected set of frequency resources for tone reservation includes one or more resource blocks of the set of resource blocks.

In some examples of the method, apparatuses, and non-transitory computer-readable medium described herein, the set of candidate frequency resources includes a set of resource blocks, and where the selected set of frequency resources for tone reservation includes one or more resource elements of one or more resource blocks of the set of resource blocks.

In some examples of the method, apparatuses, and non-transitory computer-readable medium described herein, the set of candidate frequency resources includes a resource block, and where the selected set of frequency resources for tone reservation includes one or more resource elements of the resource block.

In some examples of the method, apparatuses, and non-transitory computer-readable medium described herein, the tone reservation may be for an algorithm configured to reduce a peak-to-average power ratio (PAPR) associated with the one or more other frequency resources and the selected set of frequency resources.

A method of wireless communications at a base station is described. The method may include transmitting, to a UE, reference signals associated with a set of candidate frequency resources for tone reservation, receiving, from the UE, an indication of a set of frequency resources for tone reservation, where the set of frequency resources for tone reservation are associated with a lower signal quality than one or more other frequency resources within the set of candidate frequency resources, and transmitting information to the UE via the one or more other frequency resources.

An apparatus for wireless communications at a base station is described. The apparatus may include a processor, memory coupled with the processor, and instructions stored in the memory. The instructions may be executable by the processor to cause the apparatus to transmit, to a UE, reference signals associated with a set of candidate frequency resources for tone reservation, receive, from the UE, an indication of a set of frequency resources for tone reservation, where the set of frequency resources for tone reservation are associated with a lower signal quality than one or more other frequency resources within the set of candidate frequency resources, and transmit information to the UE via the one or more other frequency resources.

Another apparatus for wireless communications at a base station is described. The apparatus may include means for transmitting, to a UE, reference signals associated with a set of candidate frequency resources for tone reservation, receiving, from the UE, an indication of a set of frequency resources for tone reservation, where the set of frequency resources for tone reservation are associated with a lower signal quality than one or more other frequency resources within the set of candidate frequency resources, and transmitting information to the UE via the one or more other frequency resources.

A non-transitory computer-readable medium storing code for wireless communications at a base station is described. The code may include instructions executable by a processor to transmit, to a UE, reference signals associated with a set of candidate frequency resources for tone reservation, receive, from the UE, an indication of a set of frequency resources for tone reservation, where the set of frequency resources for tone reservation are associated with a lower signal quality than one or more other frequency resources within the set of candidate frequency resources, and transmit information to the UE via the one or more other frequency resources.

Some examples of the method, apparatuses, and non-transitory computer-readable medium described herein may further include operations, features, means, or instructions for configuring one or more signals to reduce a peak-to-average power ratio (PAPR) associated with transmitting the information, and transmitting, based on the indication, the one or more signals via the indicated set of frequency resources for tone reservation.

In some examples of the method, apparatuses, and non-transitory computer-readable medium described herein, receiving the indication of the set of frequency resources for tone reservation may include operations, features, means, or instructions for receiving a channel state information report including the indication, the channel state information report further indicating the one or more other frequency resources.

Some examples of the method, apparatuses, and non-transitory computer-readable medium described herein may further include operations, features, means, or instructions for receiving a channel state information report that indicates the one or more other frequency resources, where the indication of the set of frequency resources for tone reservation may be received apart from the channel state information report.

In some examples of the method, apparatuses, and non-transitory computer-readable medium described herein, the set of candidate frequency resources includes a set of resource blocks, and where the set of frequency resources for tone reservation includes one or more resource blocks of the set of resource blocks.

In some examples of the method, apparatuses, and non-transitory computer-readable medium described herein, the set of candidate frequency resources includes a set of resource blocks, and where the set of frequency resources for tone reservation includes one or more resource elements of one or more resource blocks of the set of resource blocks.

In some examples of the method, apparatuses, and non-transitory computer-readable medium described herein, the set of candidate frequency resources includes a resource block, and where the set of frequency resources for tone reservation includes one or more resource elements of the resource block.

### BRIEF DESCRIPTION OF THE DRAWINGS

FIG. 1 illustrates an example of a system for wireless communications that supports frequency reporting for tone reservation in accordance with aspects of the present disclosure.

FIG. 2 illustrates an example of a resource allocation scheme that supports frequency reporting for tone reservation in accordance with aspects of the present disclosure.

FIG. 3 illustrates an example of a resource allocation scheme that supports frequency reporting for tone reservation in accordance with aspects of the present disclosure.

FIG. 4 illustrates an example of a process flow that supports frequency reporting for tone reservation in accordance with aspects of the present disclosure.

FIGS. 5 and 6 show block diagrams of devices that support frequency reporting for tone reservation in accordance with aspects of the present disclosure.

FIG. 7 shows a block diagram of a communications manager that supports frequency reporting for tone reservation in accordance with aspects of the present disclosure.

FIG. 8 shows a diagram of a system including a device that supports frequency reporting for tone reservation in accordance with aspects of the present disclosure.

FIGS. 9 and 10 show block diagrams of devices that support frequency reporting for tone reservation in accordance with aspects of the present disclosure.

FIG. 11 shows a block diagram of a communications manager that supports frequency reporting for tone reservation in accordance with aspects of the present disclosure.

FIG. 12 shows a diagram of a system including a device that supports frequency reporting for tone reservation in accordance with aspects of the present disclosure.

FIGS. 13 through 16 show flowcharts illustrating methods that support frequency reporting for tone reservation in accordance with aspects of the present disclosure.

### DETAILED DESCRIPTION

In some examples of a wireless communications system (e.g., a new radio (NR) system), a transmitting device (e.g., a base station) may configure a transmission across a set of frequency resources (e.g., a set of subcarriers). In some examples, to reduce a peak-to-average power ratio (PAPR) and improve power efficiency, the transmitting device may reserve one or more tones (e.g., one or more frequency resources, such as one or more subcarriers, resource blocks (RBs), resource elements (REs), or the like) for PAPR reduction. The transmitting device may transmit one or more PAPR reduction signals on the reserved tones and data signals (e.g., signals carrying any kind of information for decoding and use by a receiving device) on the remaining tones of the set of frequency resources.

The selection of which tones to use as reserved tones may impact throughput. For example, if the transmitting device reserves tones with high signal quality, and uses such tones for PAPR reduction signals, the transmitting device may attempt to transmit data signals over tones having relatively lower signal quality. This may result in increased interference, one or more failed transmissions, decreased throughput, increased system latency, and decreased user experience.

In some examples, to improve throughput while using tone reservation to reduce PAPR, a receiving device (e.g., a user equipment (UE)), may identify one or more tones that have poor signal quality, according to one or more metrics. The receiving device may transmit an indication of the one or more tones having poor signal quality to the base station. The indication may be included in a channel state information (CSI) report, or may be included in a separate report or other message apart from the CSI report. The transmitting device may reserve one or more of the identified tones having poor signal quality for PAPR reduction signals, and the transmitting device may transmit data signals over tones that have relatively higher signal quality.

Particular aspects of the subject matter described herein may be implemented to realize one or more advantages. For example, the described techniques may support improvements in system efficiency such that a transmitting device may receive a report indicating a number of frequency resources with low signal quality for PAPR reduction tone reservation. As another example, the transmitting device may reserve the indicated tones for PAPR reduction, and may increase throughput and conserve battery power by reducing PAPR and transmitting data on tones with high signal quality. One of ordinary skill in the art may appreciate further advantages.

Aspects of the disclosure are initially described in the context of wireless communications systems. Aspects of the disclosure are further illustrated by and described with reference to resource allocation schemes and process flows. Aspects of the disclosure are further illustrated by and described with reference to apparatus diagrams, system diagrams, and flowcharts that relate to frequency reporting for tone reservation.

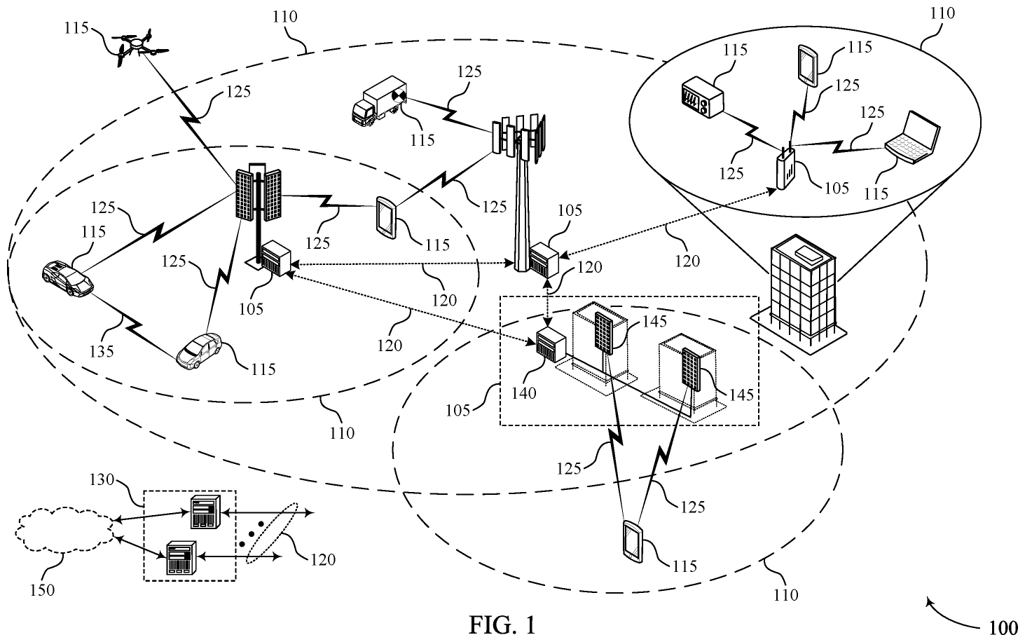

FIG. 1 illustrates an example of a wireless communications system 100 that supports frequency reporting for tone reservation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a receiving device (e.g., a UE 115), may identify one or more tones that have poor signal quality, based on one or more metrics. The receiving device may transmit an indication of one or more frequency resources (e.g., one or more tones) that have poor signal quality to a transmitting device (e.g., a base station). The transmitting device may reserve one or more of the identified tones for PAPR reduction signals, and may transmit data signals over tones that have relatively higher signal quality.

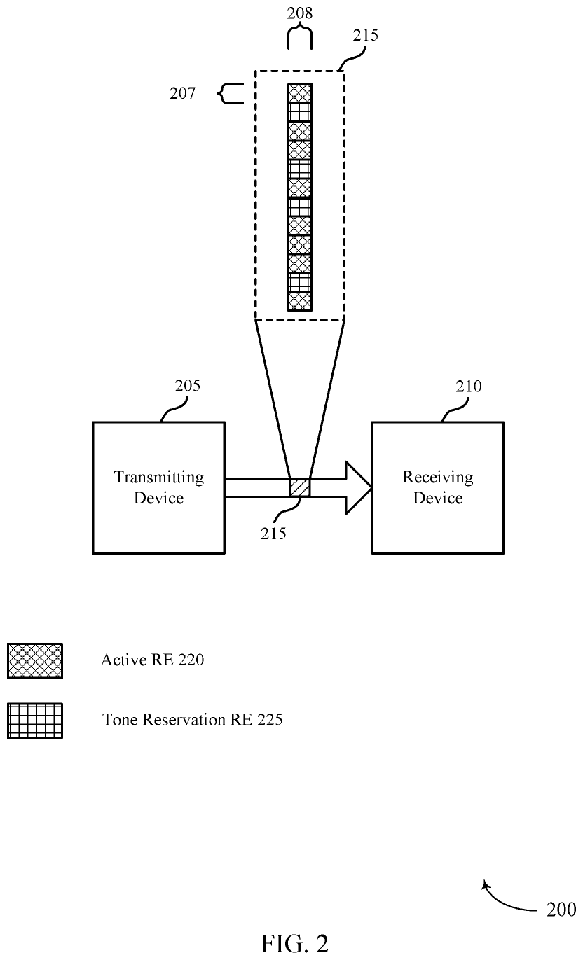

FIG. 2 illustrates an example of a resource allocation scheme 200 that supports frequency reporting for tone reservation in accordance with aspects of the present disclosure. In some examples, resource allocation scheme 200 may implement aspects of wireless communication system 100. Transmitting device 205 and receiving device 210 may each be example of a UE 115 or a base station 105 as described with reference to FIG. 1.

In some cases, transmitting device 205 may transmit transmission 215 to receiving device 210. Transmission 215 may span a set of REs. Each RE may span or otherwise correspond to a respective frequency or frequency range (e.g., a subcarrier 207) and a duration of time (e.g., time duration 208). Transmission 215 may be, for example, an OFDM signal. In some examples, transmissions 215 may experience higher PAPRs are compared to signals modulated using other schemes. As such, OFDM signals may be more likely to be clipped by a power amplifier. Such clipping may be more detrimental as a size of a constellation increases (e.g., from 4 quadrature amplitude modulation (QAM) to 256 QAM to 1024 QAM and so on).

To reduce clipping, improve the efficiency of a power amplifier at transmitting device 205, or otherwise improve communication efficiencies, transmitting device 205 may transmit PAPR reduction signals in one or more reserved tones (frequencies). In some examples, transmitting device 205 may transmit data (e.g., information-carrying) signals in active REs 220 corresponding to active tones. Tones that do not correspond to active REs 220 (e.g., non-activated subcarriers) may be referred to as empty tones corresponding to empty REs. The so-called empty REs may not include data from the transmitting device 205 and may not carry information. However, in some examples, empty REs may be reserved for PAPR reduction signals. In such examples, tone reservation REs 225 may include one or more peak-cancelling signals that lower the PAPR of transmission 215 in the time domain. In some cases, a peak-cancelling signal may be referred to as a dummy signal, due to not carrying meaningful information.

The signals transmitted in the tone reservation REs 225 (e.g., using one or more reserved tones) may carry a signal that minimizes or reduces the PAPR of the signal by lowering the peaks of transmission 215 in the time domain. By using the tone reservation REs 225 as described herein, a lower PAPR may be achieved. In some cases, due to a lower PAPR, a lower power backoff may be used by a power amplifier of the transmitting device 205, resulting in more efficient power expenditures at transmitting device 205, or other benefits. For example, power efficiency may be improved, signal processing complexity may be reduced, or other benefits may also result at receiving device 210.

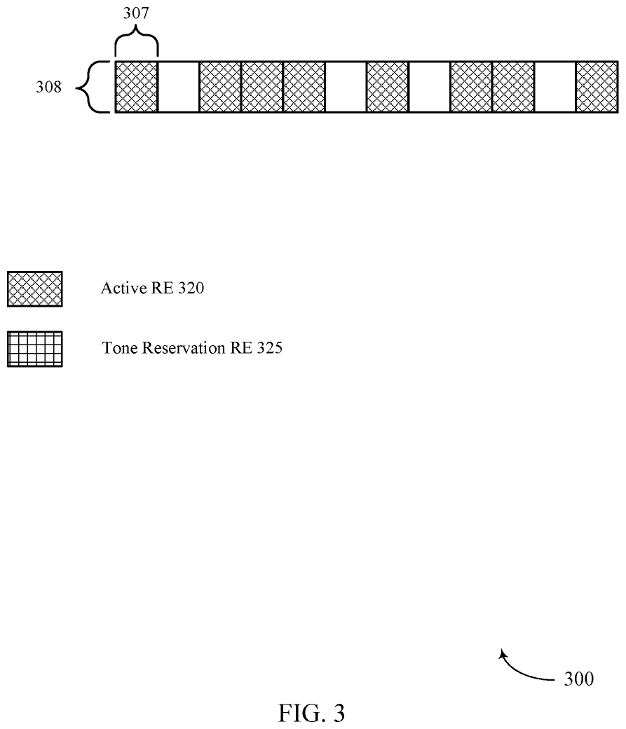

In some cases, as described with reference to FIG. 3, a transmitting device 205 may apply an algorithm to select which tones are active tones (e.g., which REs are active REs 220) and which tones or tone reservation tones (e.g., which REs are tone reservation REs 225). The algorithm may not consider signal quality metrics or other throughput-relevant consideration, and which REs which may result in decreased throughput, increased system latency, and decreased user experience. To improve efficiency and increase the likelihood of successful communications, a transmitting device 205 may receive an indication of one or more frequencies with low signal quality from receiving device 210, and may select the indicated frequencies as reserved tones (e.g., for transmitting the tone reservation REs 225).

FIG. 3 illustrates an example of a resource allocation scheme 300 that supports frequency reporting for tone reservation in accordance with aspects of the present disclosure. In some examples, resource allocation scheme 300 may implement aspects of wireless communication system 100. In some examples, a transmitting device (e.g., a base station 105 or a UE 115 as described with reference to wireless communications system 100) may implement resource allocation scheme 300.

Resource allocation scheme 300 may include, for a transmission 215 as described with reference to FIG. 2, active REs 320 corresponding to active tones and tone reservation REs 325 corresponding to reserved tones. Each RE may span a set of frequencies (e.g., a subcarrier 307) and a duration of time (e.g., time duration 308). Active REs 220 may include one or more signals that convey information bits as described with reference to FIG. 2. The active REs 220 may be modulated according to OFDM procedures. Tone reservation REs 305, may not include data signals transmitted by the transmitting device 205. Instead, transmitting device 205 may use various algorithms to generate one or more signals configured to reduce PAPR across the active and reserved tones (e.g., a collective PAPR for the active and reserved tones in combination), and may use the tone reservation REs 325 to transmit such signals. For example, such signals may be peak-canceling signals configured to have peaks (maximums or minimums) in the time domain that offset time domain peaks associated with the signals transmitted via the active REs 320. Transmitting device 205 may thus transmit data signals over active REs 320 and may transmit one or more signals that are modulated for PAPR reduction in tone reservation REs 325.

For purposes of PAPR reduction, a choice of which subcarriers 307 to use for PAPR reduction may not be important, for at least some tone reservation algorithms. However, which subcarriers 307 are selected as active REs 320 and which subcarriers 307 are selected are tone reservation REs 325 may have a direct effect on throughout. For example, to achieve a highest possible throughput, a transmitting device may transmit data over subcarriers 37 having the highest signal quality of available subcarriers 307. If one or more active REs 320 have low signal quality (e.g., experience spurs, fading, interference, or the like), while one or more tone reservation REs 325 have higher signal quality, then transmitting device 205 may send transmissions 215 to a receiving device 210 with a lower throughput than would have been possible if the transmission 215 were sent using active REs 320 with highest available signal quality. That is, if transmitting device 205 uses subcarriers 307 with high signal quality for PAPR reduction and uses subcarriers 307 with lower signal quality for data transmissions, then the transmitting device may experience reduced throughput.

In some examples, receiving device 210 may transmit, to transmitting device 205, an indication of one or more subcarriers 307 having low (poor) signal quality, as to that transmitting device 205 may use such subcarriers 307 for tone reservation (e.g., for tone reservation REs 325). Use of tones having poor signal quality as reserved tones may improve throughput without adversely impacting (or with little impact on) the extent of PAPR reduction, and thus may increase system efficiency. For example, receiving device 210 may select and indicate the absolute worst tone(s) within a set of candidate tones for tone reservation (e.g., within a communications bandwidth configured for the receiving device 210). As another example, receiving device 210 may identify a set of tones having a sufficient signal quality (e.g., above a threshold, per one or more metrics), and receiving device 210 may select and indicate the absolute worst tone(s) within the set of tones having sufficient signal quality (e.g., the worst tones among a group of tones having sufficient signal quality, as opposed to the absolute worst tones).

The tones to be used for tone reservation may be selected and indicated at any level of granularity (e.g., resource blocks (RBs), REs). Worst frequency resources (and thus frequency resources selected and indicated for tone reservation) may include subcarriers 307 that experience strong fading, have spurs, experience strong interference, or one or more other aspects of poor signal quality, as determined according to one or more associated metrics. Such reporting may result in improved overall throughput when a base station implements tone reservation targeting PAPR reduction (e.g., which reduces power consumption and improves battery life) using indicated frequency resources.

In some examples, receiving device 210 may additionally transmit, to transmitting device 205, an indication of one or more subcarriers 307 having highest or best signal quality (e.g., a channel state information (CSI) report). CSI may be wideband or narrowband. Receiving device 210 may transmit an indication of selected tones for tone reservation either as an additional part (e.g., field or set of fields) of a CSI report, or as a separate message (e.g., separate report) that is distinct from any CSI report.

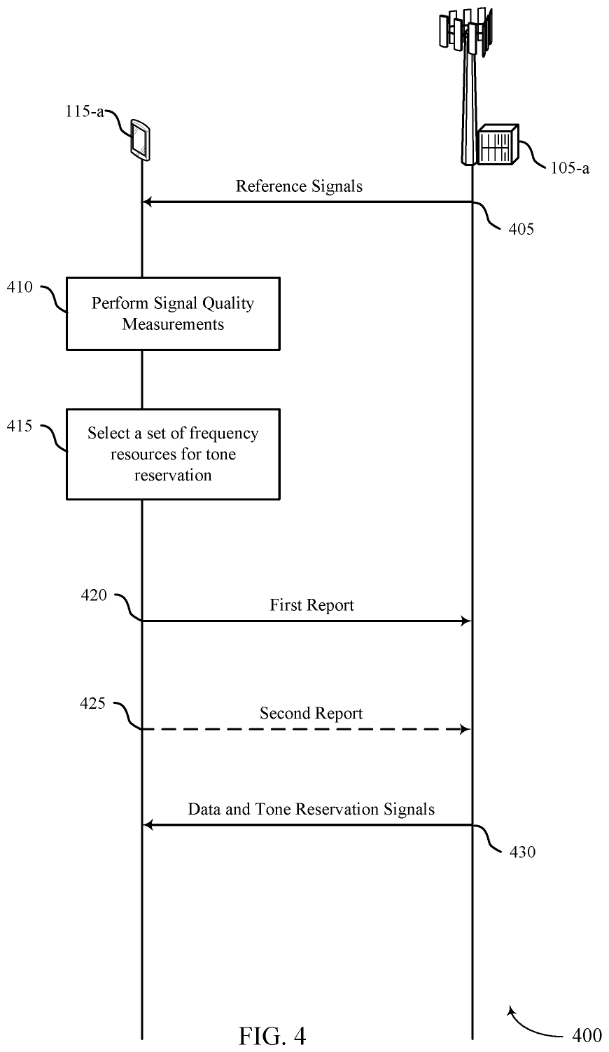

FIG. 4 illustrates an example of a process flow 400 that supports frequency reporting for tone reservation in accordance with aspects of the present disclosure. In some examples, process flow 400 may implement aspects of wireless communication system 100. In some examples, process flow 400 may include a base station 105-a, which may be an example and a base station 105 as described with reference to FIG. 1, or a transmitting device 205 described with reference to FIGS. 2 and 3, or a combination thereof. Process flow 400 may also include a UE 115-a, which may be an example of a UE 115 as described with reference to FIG. 1, or a receiving device 210 as described with reference to FIGS. 2 and 3.

At 405, base station 105-a may transmit, and UE 115-a may receive, one or more reference signals, which may be used by UE 115-a to determine signal quality across a set of frequency resources. Any subset of all of the frequency resources within the set of frequency resources may be candidate frequency resources for tone reservation. The reference signals may be, for example, channel state information reference signals (CSI-RSs).

At 410, transmitting device may perform one or more signal quality measurements on the reference signals received at 405. By performing signal quality measurements, UE 115-a may determine which frequency resources (e.g., which subcarriers) experience strong fading, have spurs, experience strong interference, distortion, or otherwise have poor signal quality. For example, the UE 115-a may perform one or more measurements that may be performed in connect with CSI reporting, but may use the measurements to identify frequency resources associated with having poor signal quality (e.g., rather than high signal quality). Based on performing the measurements, UE 115-a may determine a level of interference, an amount of channel fading, a received signal power, an extent of harmonic distortion, or any combination thereof.

At 415, UE 115-a may select a set of frequency resources for tone reservation. For instance, the frequency resources via which the UE 115-a receives the reference signals may be or include a set of candidate frequency resources for tone reservation. The candidate frequency resources may be REs, RBs, or the like, which may be candidates for reservation by base station 105-a for data signals or for PAPR reduction, as described with reference to FIGS. 2 and 3. UE 115-a may determine, based on the measurements performed at 410, which of the candidate frequency resources have higher signal quality and which have lower signal quality. UE 115-a may select, for tone reservation, a set of frequency resources of the candidate frequency resources that have lower signal quality than at least one or more other frequency resources within the set of candidate frequency resources.

In some examples, UE 115-a may select frequency resources for tone reservation (e.g., for PAPR reduction) at an RE granularity. For instance, UE 115-a may select, from one or more RBs, one or more individual REs that have poor signal quality. In some examples UE 115-a may select frequency resources for tone reservation (e.g., for PAPR reduction) at RB granularity. For instance, UE 115-a may select, from a set of RBs, one or more RBs that have poor signal quality.

In some examples, UE 115-a may report up to a fixed number of selected frequency resources (e.g., the UE 115-a may be configured to select and indicate a fixed number of frequency resources for tone reservation). The fixed number may be standardized, preconfigured, determined by UE 115-a, or indicated by base station 105-a. For instance, UE 115-a may select a frequency resource (e.g., an RE or an RB) that has a lowest signal quality of the candidate frequency resources. UE 115-a may then select one or more additional frequency resources in ascending order of signal quality relative to the frequency resource having the lowest signal quality, until a quantity of frequency resources equal to the fixed (target) quantity have been selected.

In some examples, UE 115-a may identify a group of frequency resources within the set of candidate frequency resources that each have a signal quality that satisfies (e.g., meets or exceeds) a threshold signal quality, and the UE 115-a may select and indicate for tone reservation one or more frequency resources having the lowest signal quality within that group. The threshold signal quality may be standardized, preconfigured, indicated by base station 105-a, or determined by UE 115-a. UE 115-a may perform signal quality measurements at 410 on all of the candidate frequency resources, and may select for tone reservation from among the frequency resources that have at least the threshold signal quality (e.g., may select one or more frequency resources that have the lowest signal quality among those frequency resources with a signal quality that satisfies the threshold).

UE 115-a may in some cases select up to a fixed number of frequency resources for tone reservation from among such a group that each have at least the threshold signal quality. For instance, UE 115-a may select a frequency resource having a lowest signal quality from the set of frequency resources that satisfy the threshold signal quality. Then, UE 115-a may select one or more additional frequency resources that also satisfy the threshold signal quality in ascending order of threshold signal quality up to the fixed number of frequency resources. In such examples, UE 115-a may select and report only frequency resources that satisfy the signal quality threshold (e.g., even if the total number of frequency resources that satisfy the signal quality threshold is less than the fixed number of frequency resources), or may first select frequency resources that satisfy the signal quality threshold in ascending order of signal quality, and may then select additional frequency resources in ascending order of signal quality up to the fixed number of frequency resources, or may select frequency resources that satisfy the signal quality threshold in ascending order of signal quality up to the fixed number of frequency resources (e.g., and not selecting the rest of the frequency resources that do satisfy the threshold signal quality if the number of frequency resources that satisfy the threshold signal quality exceeds the fixed number of frequency resources).

At 420, UE 115-a may transmit a first report (e.g., a tone reservation report) that includes the indication of the selected (e.g., low signal quality) set of frequency resources (e.g., REs of an RB or set of RBs, or RBs of a set of RBs) for tone reservation for PAPR reduction. Though termed a report herein, it is to be understood that this is not limiting, and the indication of the selected set of frequency resources may be any type of message. Upon receiving the first report at 420, base station 105-a may allocate one or more of the selected set of frequency resources as reserved tones for tone reservation for PAPR reduction (e.g., as tone reservation REs 325, or otherwise to carry PAPR-reducing signals).

At 425, UE 115-a may transmit a second report, which may be a CSI report, and may include an indication of or more frequency resources (e.g., REs of an RB or set of RBs, or RBs of a set of RBs) that have higher signal quality than those indicated for tone reservation at 420. Upon receiving the CSI report at 420, base station 105-a may allocate best frequency resources indicated by the CSI for signal transmissions (e.g., as active REs 320). In some examples, the first report at 420 may alternatively be included in (e.g., as one or more fields within) a CSI report at 425.

At 430, base station 105-a may transmit, and UE 115-a may receive, downlink information (e.g., data or control information) from the base station 105-a over the frequency resources that were not selected for tone reservation. Base station 105-a also may transmit, and UE 115-a may receive, over the frequency resources that were selected for tone reservation, one or more signals configured to reduce PAPR associated with the received information (e.g., to reduce a PAPR associated with a combination of the reserved frequency resources and the frequency resources used to carry the downlink information). For example, the signals carried via the reserved tones may be configured according to an algorithm for reducing PAPR (e.g., by offsetting positive or negative peaks associated with the signals that carry the information at 430).

Techniques described herein may result in successful PAPR reduction (e.g., which may result in decreased power expenditures and improved battery life) with improved throughput and system efficiency relative to other tone reservation techniques.

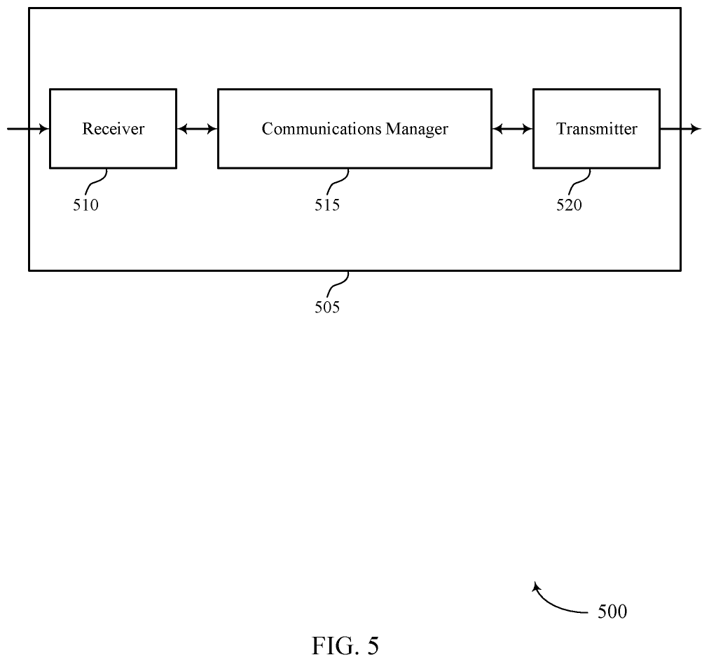

FIG. 5 shows a block diagram 500 of a device 505 that supports frequency reporting for tone reservation in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

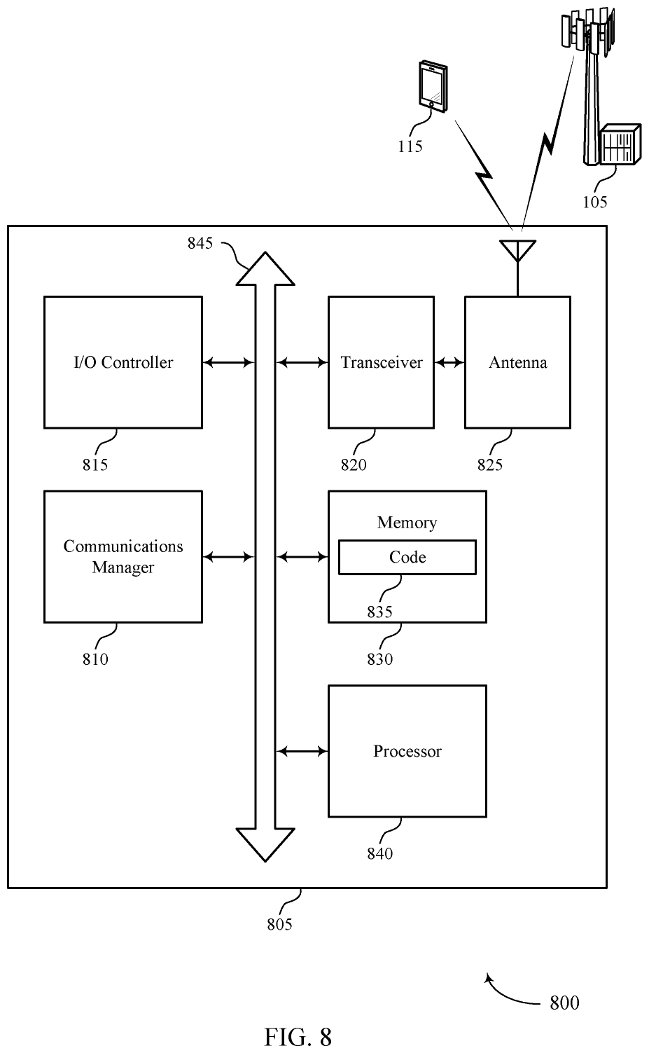

The receiver 510 may receive information such as packets, user data, or control information associated with various information channels (e.g., control channels, data channels, and information related to frequency reporting for tone reservation, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a base station, reference signals associated with a set of candidate frequency resources for tone reservation, perform one or more signal quality measurements on the reference signals, select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources, transmit, to the base station, an indication of the selected set of frequency resources for tone reservation, and receive, based on the indication, information from the base station via the one or more other frequency resources. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

In some examples, the communications manager 515 may be implemented as an integrated circuit or chipset for a mobile device modem, and the receiver 510 and transmitter 520 may be implemented as analog components (e.g., amplifiers, filters, antennas) coupled with the mobile device modem to enable wireless transmission and reception over one or more bands.

The communications manager 515 as described herein may be implemented to realize one or more potential advantages. One implementation may allow the device to reduce PAPR to extend battery life and increase power efficiency, while increasing throughput, decreasing system latency, and improving user experience.

Based on techniques for efficiently communicating maximum number of layers for a device as described herein, a processor of a UE 115 (e.g., controlling the receiver 510, the transmitter 520, or a transceiver 820 as described with respect to FIG. 8) may increase system efficiency and decrease unnecessary processing at a device.

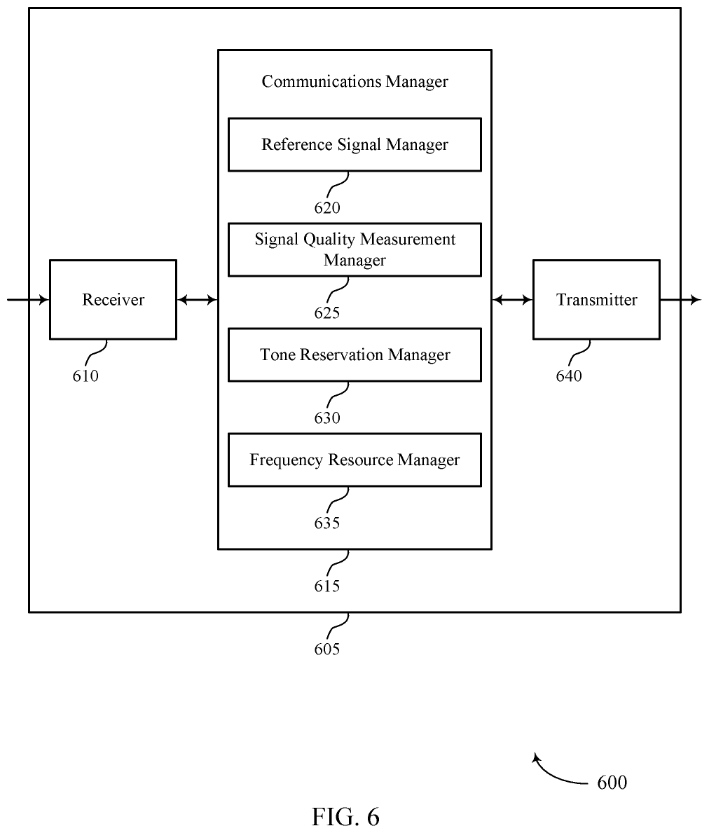

FIG. 6 shows a block diagram 600 of a device 605 that supports frequency reporting for tone reservation in accordance with aspects of the present disclosure. The device 605 may be an example of aspects of a device 505, or a UE 115 as described herein. The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to frequency reporting for tone reservation, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a reference signal manager 620, a signal quality measurement manager 625, a tone reservation manager 630, and a frequency resource manager 635. The communications manager 615 may be an example of aspects of the communications manager 810 described herein.

The reference signal manager 620 may receive, from a base station, reference signals associated with a set of candidate frequency resources for tone reservation.

The signal quality measurement manager 625 may perform one or more signal quality measurements on the reference signals.

The tone reservation manager 630 may select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources and transmit, to the base station, an indication of the selected set of frequency resources for tone reservation.

The frequency resource manager 635 may receive, based on the indication, information from the base station via the one or more other frequency resources.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

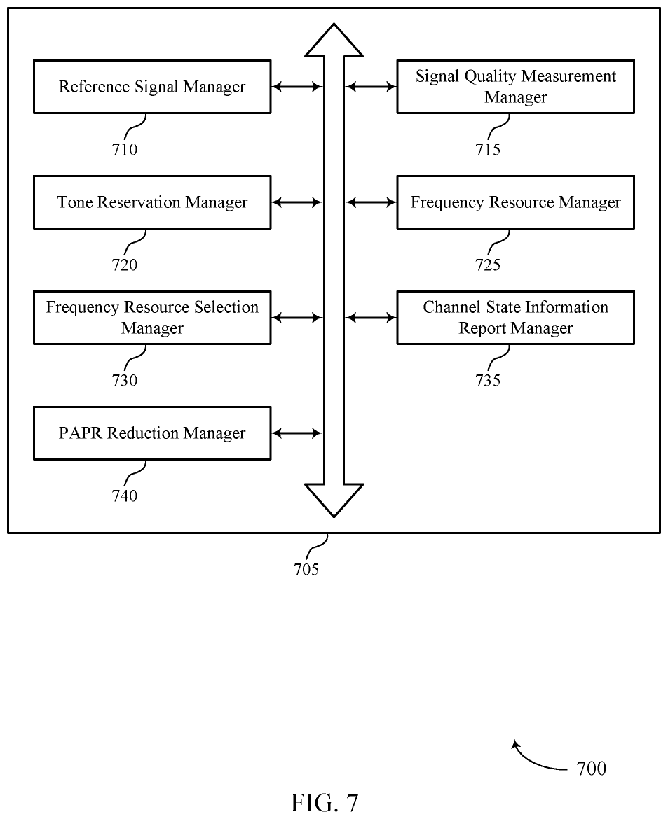

FIG. 7 shows a block diagram 700 of a communications manager 705 that supports frequency reporting for tone reservation in accordance with aspects of the present disclosure. The communications manager 705 may be an example of aspects of a communications manager 515, a communications manager 615, or a communications manager 810 described herein. The communications manager 705 may include a reference signal manager 710, a signal quality measurement manager 715, a tone reservation manager 720, a frequency resource manager 725, a frequency resource selection manager 730, a channel state information report manager 735, and a PAPR reduction manager 740. Each of these modules may communicate, directly or indirectly, with one another (e.g., via one or more buses).

The reference signal manager 710 may receive, from a base station, reference signals associated with a set of candidate frequency resources for tone reservation.

The signal quality measurement manager 715 may perform one or more signal quality measurements on the reference signals.

In some examples, the signal quality measurement manager 715 may identify within the set of candidate frequency resources, based on the one or more signal quality measurements, a group of frequency resources that each satisfy a threshold signal quality. In some examples, the signal quality measurement manager 715 may determine for a frequency resource within the set of candidate frequency resources, based on the one or more signal quality measurements, a level of interference, an amount of channel fading, a received signal power, an extent of harmonic distortion, or any combination thereof, where the selecting is based on the determining.

The tone reservation manager 720 may select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources. In some examples, the tone reservation manager 720 may transmit, to the base station, an indication of the selected set of frequency resources for tone reservation.

The frequency resource manager 725 may receive, based on the indication, information from the base station via the one or more other frequency resources. In some examples, the frequency resource manager 725 may receive, based on the indication, one or more signals via the selected set of frequency resources for tone reservation, where the one or more signals are configured to reduce a PAPR associated with receiving the information. In some cases, the set of candidate frequency resources includes a set of resource blocks, and where the selected set of frequency resources for tone reservation includes one or more resource blocks of the set of resource blocks. In some cases, the set of candidate frequency resources includes a set of resource blocks, and where the selected set of frequency resources for tone reservation includes one or more resource elements of one or more resource blocks of the set of resource blocks. In some cases, the set of candidate frequency resources includes a resource block, and where the selected set of frequency resources for tone reservation includes one or more resource elements of the resource block.

The frequency resource selection manager 730 may select from the set of candidate frequency resources, based on the one or more signal quality measurements, a first frequency resource having a lowest signal quality, where the selected set of frequency resources includes the first frequency resource. In some examples, selecting from the set of candidate frequency resources, based on the one or more signal quality measurements, one or more additional frequency resources in ascending order of signal quality relative to the first frequency resource until a target quantity of frequency resources are selected, where the selected set of frequency resources further includes the one or more additional frequency resources. In some examples, selecting from the group of frequency resources, based on the one or more signal quality measurements, a first frequency resource having a lowest signal quality, where the selected set of frequency resources includes the first frequency resource. In some examples, selecting from the group of frequency resources, based on the one or more signal quality measurements, one or more additional frequency resources in ascending order of signal quality relative to the first frequency resource until a target quantity of frequency resources are selected, where the selected set of frequency resources further includes the one or more additional frequency resources.

The channel state information report manager 735 may transmit a channel state information report including the indication, the channel state information report further indicating the one or more other frequency resources. In some examples, the channel state information report manager 735 may transmit a channel state information report that indicates the one or more other frequency resources, where the indication of the selected set of frequency resources for tone reservation is transmitted apart from the channel state information report.

The PAPR reduction manager 740 may perform tone reservation for or based on an algorithm configured to reduce a PAPR associated with the one or more other frequency resources and the selected set of frequency resources.

FIG. 8 shows a diagram of a system 800 including a device 805 that supports frequency reporting for tone reservation in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a base station, reference signals associated with a set of candidate frequency resources for tone reservation, perform one or more signal quality measurements on the reference signals, select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources, transmit, to the base station, an indication of the selected set of frequency resources for tone reservation, and receive, based on the indication, information from the base station via the one or more other frequency resources.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting frequency reporting for tone reservation).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

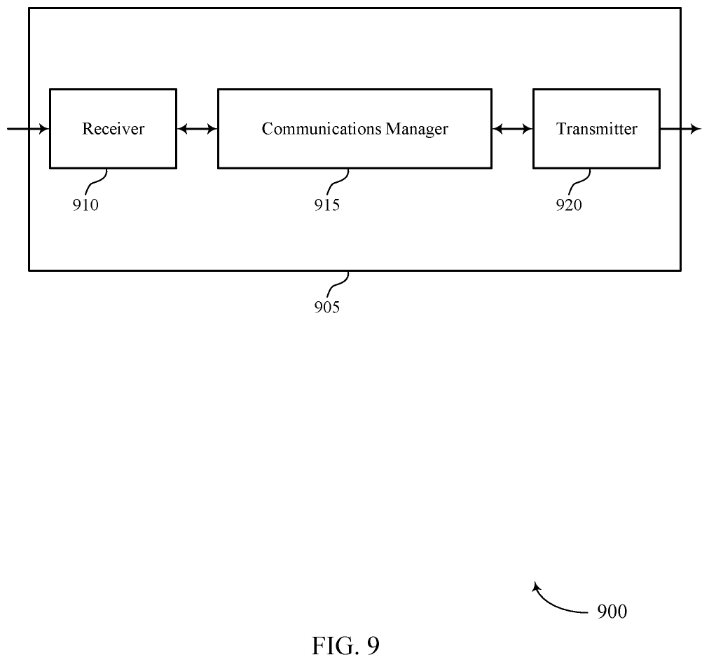

FIG. 9 shows a block diagram 900 of a device 905 that supports frequency reporting for tone reservation in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

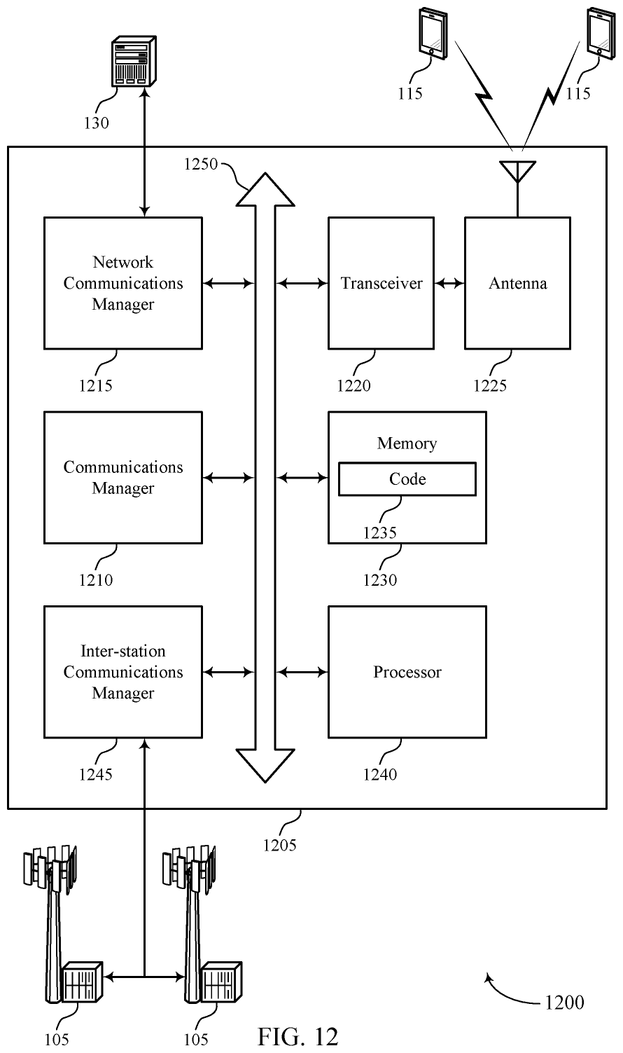

The receiver 910 may receive information such as packets, user data, or control information associated with various information channels (e.g., control channels, data channels, and information related to frequency reporting for tone reservation, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may transmit, to a UE, reference signals associated with a set of candidate frequency resources for tone reservation, receive, from the UE, an indication of a set of frequency resources for tone reservation, where the set of frequency resources for tone reservation are associated with a lower signal quality than one or more other frequency resources within the set of candidate frequency resources, and transmit information to the UE via the one or more other frequency resources. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

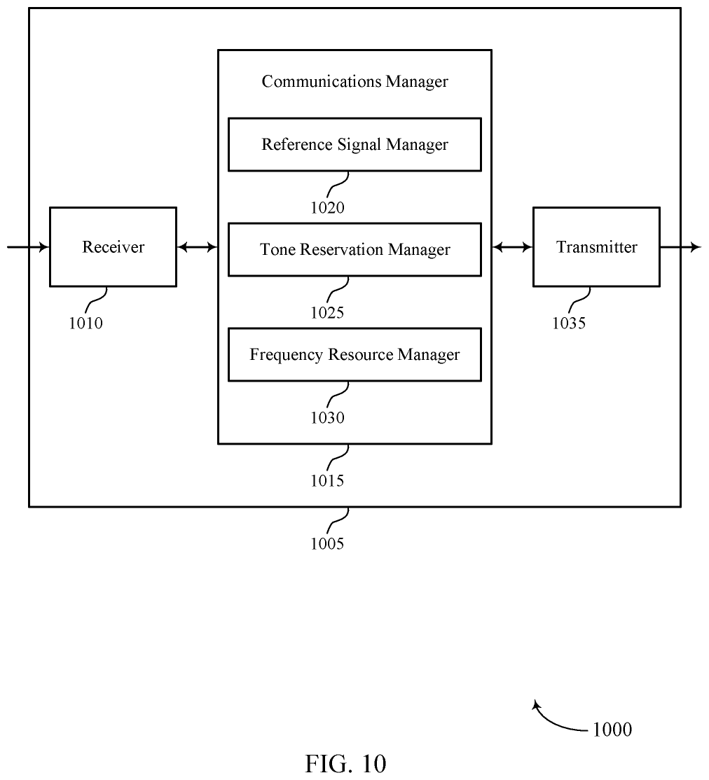

FIG. 10 shows a block diagram 1000 of a device 1005 that supports frequency reporting for tone reservation in accordance with aspects of the present disclosure. The device 1005 may be an example of aspects of a device 905, or a base station 105 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to frequency reporting for tone reservation, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a reference signal manager 1020, a tone reservation manager 1025, and a frequency resource manager 1030. The communications manager 1015 may be an example of aspects of the communications manager 1210 described herein.

The reference signal manager 1020 may transmit, to a UE, reference signals associated with a set of candidate frequency resources for tone reservation.

The tone reservation manager 1025 may receive, from the UE, an indication of a set of frequency resources for tone reservation, where the set of frequency resources for tone reservation are associated with a lower signal quality than one or more other frequency resources within the set of candidate frequency resources.

The frequency resource manager 1030 may transmit information to the UE via the one or more other frequency resources.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

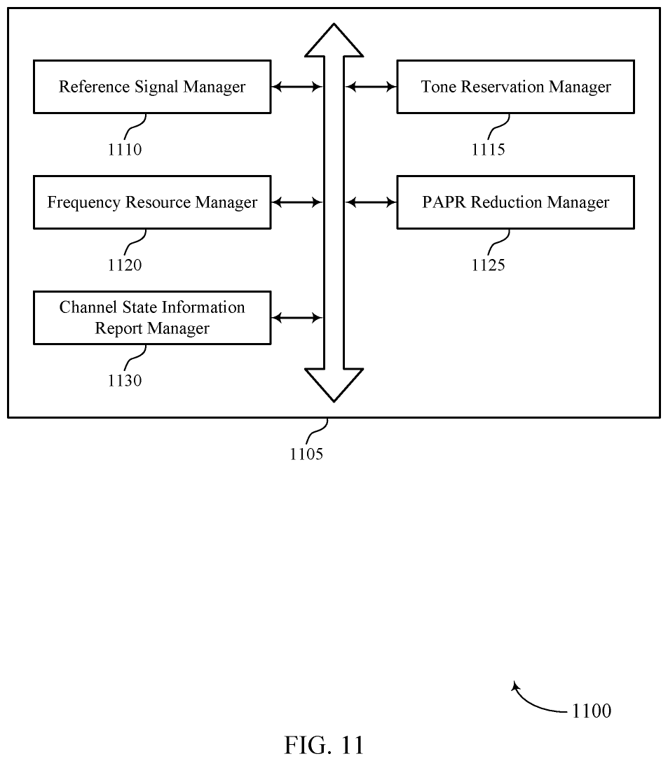

FIG. 11 shows a block diagram 1100 of a communications manager 1105 that supports frequency reporting for tone reservation in accordance with aspects of the present disclosure. The communications manager 1105 may be an example of aspects of a communications manager 915, a communications manager 1015, or a communications manager 1210 described herein. The communications manager 1105 may include a reference signal manager 1110, a tone reservation manager 1115, a frequency resource manager 1120, a PAPR reduction manager 1125, and a channel state information report manager 1130. Each of these modules may communicate, directly or indirectly, with one another (e.g., via one or more buses).

The reference signal manager 1110 may transmit, to a UE, reference signals associated with a set of candidate frequency resources for tone reservation.

The tone reservation manager 1115 may receive, from the UE, an indication of a set of frequency resources for tone reservation, where the set of frequency resources for tone reservation are associated with a lower signal quality than one or more other frequency resources within the set of candidate frequency resources.

The frequency resource manager 1120 may transmit information to the UE via the one or more other frequency resources. In some examples, the frequency resource manager 1120 may transmit, based on the indication, the one or more signals via the indicated set of frequency resources for tone reservation. In some cases, the set of candidate frequency resources includes a set of resource blocks, and where the set of frequency resources for tone reservation includes one or more resource blocks of the set of resource blocks. In some cases, the set of candidate frequency resources includes a set of resource blocks, and where the set of frequency resources for tone reservation includes one or more resource elements of one or more resource blocks of the set of resource blocks. In some cases, the set of candidate frequency resources includes a resource block, and where the set of frequency resources for tone reservation includes one or more resource elements of the resource block.

The PAPR reduction manager 1125 may configure one or more signals to reduce a PAPR associated with transmitting the information.

The channel state information report manager 1130 may receive a channel state information report including the indication, the channel state information report further indicating the one or more other frequency resources. In some examples, the channel state information report manager 1130 may receive a channel state information report that indicates the one or more other frequency resources, where the indication of the set of frequency resources for tone reservation is received apart from the channel state information report.

FIG. 12 shows a diagram of a system 1200 including a device 1205 that supports frequency reporting for tone reservation in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may transmit, to a UE, reference signals associated with a set of candidate frequency resources for tone reservation, receive, from the UE, an indication of a set of frequency resources for tone reservation, where the set of frequency resources for tone reservation are associated with a lower signal quality than one or more other frequency resources within the set of candidate frequency resources, and transmit information to the UE via the one or more other frequency resources.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting frequency reporting for tone reservation).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

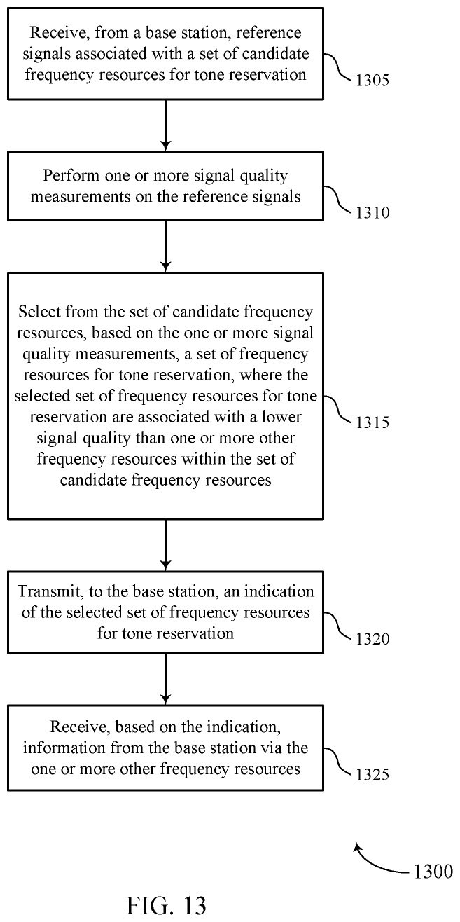

FIG. 13 shows a flowchart illustrating a method 1300 that supports frequency reporting for tone reservation in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a UE may execute a set of instructions to control the functional elements of the UE to perform the functions described below. Additionally, or alternatively, a UE may perform aspects of the functions described below using special-purpose hardware.

At 1305, the UE may receive, from a base station, reference signals associated with a set of candidate frequency resources for tone reservation. The operations of 1305 may be performed according to the methods described herein. In some examples, aspects of the operations of 1305 may be performed by a reference signal manager as described with reference to FIG. 5 through 8. Additionally or alternatively, means for performing 1305 may, but not necessarily, include, for example, antenna 825, transceiver 820, communications manager 810, memory 830 (including code 835), processor 840 and/or bus 845.

At 1310, the UE may perform one or more signal quality measurements on the reference signals. The operations of 1310 may be performed according to the methods described herein. In some examples, aspects of the operations of 1310 may be performed by a signal quality measurement manager as described with reference to FIGS. 5 through 8. Additionally or alternatively, means for performing 1310 may, but not necessarily, include, for example, antenna 825, transceiver 820, communications manager 810, memory 830 (including code 835), processor 840 and/or bus 845.

At 1315, the UE may select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources. The operations of 1315 may be performed according to the methods described herein. In some examples, aspects of the operations of 1315 may be performed by a tone reservation manager as described with reference to FIGS. 5 through 8. Additionally or alternatively, means for performing 1315 may, but not necessarily, include, for example, antenna 825, transceiver 820, communications manager 810, memory 830 (including code 835), processor 840 and/or bus 845.

At 1320, the UE may transmit, to the base station, an indication of the selected set of frequency resources for tone reservation. The operations of 1320 may be performed according to the methods described herein. In some examples, aspects of the operations of 1320 may be performed by a tone reservation manager as described with reference to FIGS. 5 through 8. Additionally or alternatively, means for performing 1320 may, but not necessarily, include, for example, antenna 825, transceiver 820, communications manager 810, memory 830 (including code 835), processor 840 and/or bus 845.

At 1325, the UE may receive, based on the indication, information from the base station via the one or more other frequency resources. The operations of 1325 may be performed according to the methods described herein. In some examples, aspects of the operations of 1325 may be performed by a frequency resource manager as described with reference to FIGS. 5 through 8. Additionally or alternatively, means for performing 1325 may, but not necessarily, include, for example, antenna 825, transceiver 820, communications manager 810, memory 830 (including code 835), processor 840 and/or bus 845.

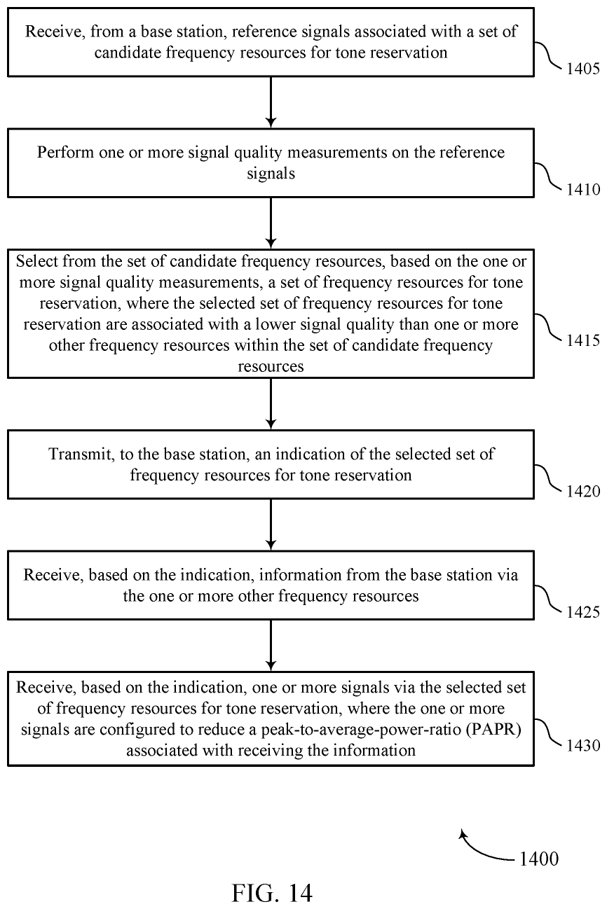

FIG. 14 shows a flowchart illustrating a method 1400 that supports frequency reporting for tone reservation in accordance with aspects of the present disclosure. The operations of method 1400 may be implemented by a UE 115 or its components as described herein. For example, the operations of method 1400 may be performed by a communications manager as described with reference to FIGS. 5 through 8. In some examples, a UE may execute a set of instructions to control the functional elements of the UE to perform the functions described below. Additionally, or alternatively, a UE may perform aspects of the functions described below using special-purpose hardware.

At 1405, the UE may receive, from a base station, reference signals associated with a set of candidate frequency resources for tone reservation. The operations of 1405 may be performed according to the methods described herein. In some examples, aspects of the operations of 1405 may be performed by a reference signal manager as described with reference to FIGS. 5 through 8. Additionally or alternatively, means for performing 1405 may, but not necessarily, include, for example, antenna 825, transceiver 820, communications manager 810, memory 830 (including code 835), processor 840 and/or bus 845.

At 1410, the UE may perform one or more signal quality measurements on the reference signals. The operations of 1410 may be performed according to the methods described herein. In some examples, aspects of the operations of 1410 may be performed by a signal quality measurement manager as described with reference to FIGS. 5 through 8. Additionally or alternatively, means for performing 1410 may, but not necessarily, include, for example, antenna 825, transceiver 820, communications manager 810, memory 830 (including code 835), processor 840 and/or bus 845.

At 1415, the UE may select from the set of candidate frequency resources, based on the one or more signal quality measurements, a set of frequency resources for tone reservation, where the selected set of frequency resources for tone reservation are associated with a lower signal quality than one or more other frequency resources within the set of candidate frequency resources. The operations of 1415 may be performed according to the methods described herein. In some examples, aspects of the operations of 1415 may be performed by a tone reservation manager as described with reference to FIGS. 5 through 8. Additionally or alternatively, means for performing 1415 may, but not necessarily, include, for example, antenna 825, transceiver 820, communications manager 810, memory 830 (including code 835), processor 840 and/or bus 845.

At 1420, the UE may transmit, to the base station, an indication of the selected set of frequency resources for tone reservation. The operations of 1420 may be performed according to the methods described herein. In some examples, aspects of the operations of 1420 may be performed by a tone reservation manager as described with reference to FIGS. 5 through 8. Additionally or alternatively, means for performing 1420 may, but not necessarily, include, for example, antenna 825, transceiver 820, communications manager 810, memory 830 (including code 835), processor 840 and/or bus 845.

At 1425, the UE may receive, based on the indication, information from the base station via the one or more other frequency resources. The operations of 1425 may be performed according to the methods described herein. In some examples, aspects of the operations of 1425 may be performed by a frequency resource manager as described with reference to FIGS. 5 through 8. Additionally or alternatively, means for performing 1425 may, but not necessarily, include, for example, antenna 825, transceiver 820, communications manager 810, memory 830 (including code 835), processor 840 and/or bus 845.

At 1430, the UE may receive, based on the indication, one or more signals via the selected set of frequency resources for tone reservation, where the one or more signals are configured to reduce a PAPR associated with receiving the information. The operations of 1430 may be performed according to the methods described herein. In some examples, aspects of the operations of 1430 may be performed by a frequency resource manager as described with reference to FIGS. 5 through 8. Additionally or alternatively, means for performing 1430 may, but not necessarily, include, for example, antenna 825, transceiver 820, communications manager 810, memory 830 (including code 835), processor 840 and/or bus 845.

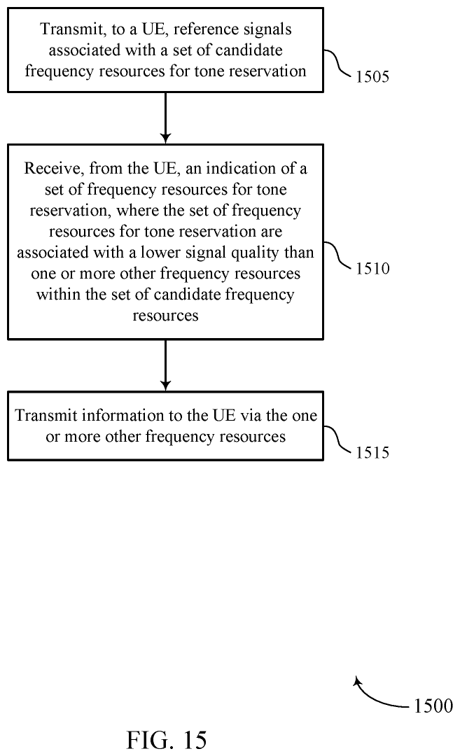

FIG. 15 shows a flowchart illustrating a method 1500 that supports frequency reporting for tone reservation in accordance with aspects of the present disclosure. The operations of method 1500 may be implemented by a base station 105 or its components as described herein. For example, the operations of method 1500 may be performed by a communications manager as described with reference to FIGS. 9 through 12. In some examples, a base station may execute a set of instructions to control the functional elements of the base station to perform the functions described below. Additionally, or alternatively, a base station may perform aspects of the functions described below using special-purpose hardware.

At 1505, the base station may transmit, to a UE, reference signals associated with a set of candidate frequency resources for tone reservation. The operations of 1505 may be performed according to the methods described herein. In some examples, aspects of the operations of 1505 may be performed by a reference signal manager as described with reference to FIGS. 9 through 12. Additionally or alternatively, means for performing 1505 may, but not necessarily, include, for example, antenna 1225, transceiver 1220, communications manager 1210, memory 1230 (including code 1235), processor 1240 and/or bus 1245.

At 1510, the base station may receive, from the UE, an indication of a set of frequency resources for tone reservation, where the set of frequency resources for tone reservation are associated with a lower signal quality than one or more other frequency resources within the set of candidate frequency resources. The operations of 1510 may be performed according to the methods described herein. In some examples, aspects of the operations of 1510 may be performed by a tone reservation manager as described with reference to FIGS. 9 through 12. Additionally or alternatively, means for performing 1510 may, but not necessarily, include, for example, antenna 1225, transceiver 1220, communications manager 1210, memory 1230 (including code 1235), processor 1240 and/or bus 1245.

At 1515, the base station may transmit information to the UE via the one or more other frequency resources. The operations of 1515 may be performed according to the methods described herein. In some examples, aspects of the operations of 1515 may be performed by a frequency resource manager as described with reference to FIGS. 9 through 12. Additionally or alternatively, means for performing 1515 may, but not necessarily, include, for example, antenna 1225, transceiver 1220, communications manager 1210, memory 1230 (including code 1235), processor 1240 and/or bus 1245.

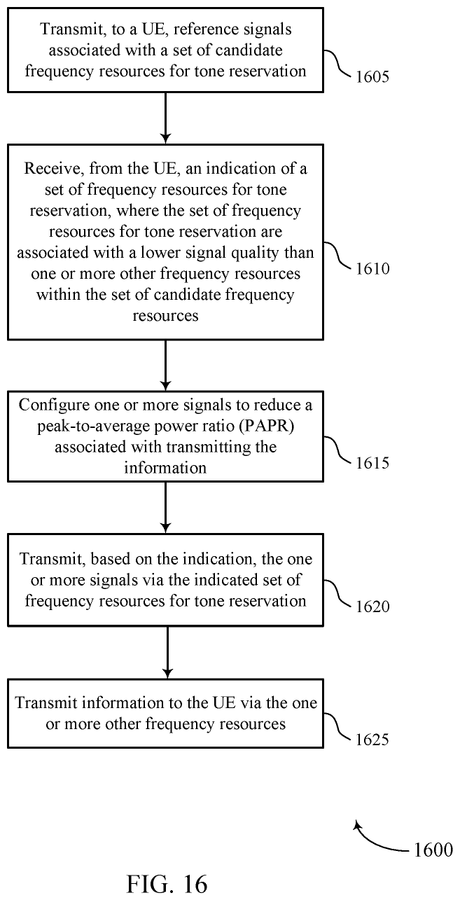

FIG. 16 shows a flowchart illustrating a method 1600 that supports frequency reporting for tone reservation in accordance with aspects of the present disclosure. The operations of method 1600 may be implemented by a base station 105 or its components as described herein. For example, the operations of method 1600 may be performed by a communications manager as described with reference to FIGS. 9 through 12. In some examples, a base station may execute a set of instructions to control the functional elements of the base station to perform the functions described below. Additionally, or alternatively, a base station may perform aspects of the functions described below using special-purpose hardware.

At 1605, the base station may transmit, to a UE, reference signals associated with a set of candidate frequency resources for tone reservation. The operations of 1605 may be performed according to the methods described herein. In some examples, aspects of the operations of 1605 may be performed by a reference signal manager as described with reference to FIGS. 9 through 12. Additionally or alternatively, means for performing 1605 may, but not necessarily, include, for example, antenna 1225, transceiver 1220, communications manager 1210, memory 1230 (including code 1235), processor 1240 and/or bus 1245.

At 1610, the base station may receive, from the UE, an indication of a set of frequency resources for tone reservation, where the set of frequency resources for tone reservation are associated with a lower signal quality than one or more other frequency resources within the set of candidate frequency resources. The operations of 1610 may be performed according to the methods described herein. In some examples, aspects of the operations of 1610 may be performed by a tone reservation manager as described with reference to FIGS. 9 through 12. Additionally or alternatively, means for performing 1610 may, but not necessarily, include, for example, antenna 1225, transceiver 1220, communications manager 1210, memory 1230 (including code 1235), processor 1240 and/or bus 1245.

At 1615, the base station may configure one or more signals to reduce a PAPR associated with transmitting the information. The operations of 1615 may be performed according to the methods described herein. In some examples, aspects of the operations of 1615 may be performed by a PAPR reduction manager as described with reference to FIGS. 9 through 12. Additionally or alternatively, means for performing 1615 may, but not necessarily, include, for example, antenna 1225, transceiver 1220, communications manager 1210, memory 1230 (including code 1235), processor 1240 and/or bus 1245.

At 1620, the base station may transmit, based on the indication, the one or more signals via the indicated set of frequency resources for tone reservation. The operations of 1620 may be performed according to the methods described herein. In some examples, aspects of the operations of 1620 may be performed by a frequency resource manager as described with reference to FIGS. 9 through 12. Additionally or alternatively, means for performing 1620 may, but not necessarily, include, for example, antenna 1225, transceiver 1220, communications manager 1210, memory 1230 (including code 1235), processor 1240 and/or bus 1245.

At 1625, the base station may transmit information to the UE via the one or more other frequency resources. The operations of 1625 may be performed according to the methods described herein. In some examples, aspects of the operations of 1625 may be performed by a frequency resource manager as described with reference to FIGS. 9 through 12. Additionally or alternatively, means for performing 1625 may, but not necessarily, include, for example, antenna 1225, transceiver 1220, communications manager 1210, memory 1230 (including code 1235), processor 1240 and/or bus 1245.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
receiving, from a base station, reference signals associated with a set of candidate frequency resources for tone reservation;
performing one or more signal quality measurements on the reference signals;
selecting from the set of candidate frequency resources, based at least in part on the one or more signal quality measurements, a set of frequency resources for tone reservation, wherein the selected set of frequency resources for tone reservation are associated with a lower signal quality than one or more other frequency resources within the set of candidate frequency resources;
transmitting, to the base station, an indication of the selected set of frequency resources for tone reservation; and
receiving, based at least in part on the indication, information from the base station via the one or more other frequency resources.

2. The method of claim 1, further comprising:
receiving, based at least in part on the indication, one or more signals via the selected set of frequency resources for tone reservation, wherein the one or more signals are configured to reduce a peak-to-average-power-ratio (PAPR) associated with receiving the information.

3. The method of claim 1, wherein the selecting comprises:
selecting from the set of candidate frequency resources, based at least in part on the one or more signal quality measurements, a first frequency resource having a lowest signal quality, wherein the selected set of frequency resources comprises the first frequency resource.

4. The method of claim 3, wherein the selecting further comprises:
selecting from the set of candidate frequency resources, based at least in part on the one or more signal quality measurements, one or more additional frequency resources in ascending order of signal quality relative to the first frequency resource until a target quantity of frequency resources are selected, wherein the selected set of frequency resources further comprises the one or more additional frequency resources.

5. The method of claim 1, wherein the selecting comprises:
identifying within the set of candidate frequency resources, based at least in part on the one or more signal quality measurements, a group of frequency resources that each satisfy a threshold signal quality; and
selecting from the group of frequency resources, based at least in part on the one or more signal quality measurements, a first frequency resource having a lowest signal quality, wherein the selected set of frequency resources comprises the first frequency resource.

6. The method of claim 5, wherein the selecting further comprises:
selecting from the group of frequency resources, based at least in part on the one or more signal quality measurements, one or more additional frequency resources in ascending order of signal quality relative to the first frequency resource until a target quantity of frequency resources are selected, wherein the selected set of frequency resources further comprises the one or more additional frequency resources.

7. The method of claim 1, wherein transmitting the indication of the selected set of frequency resources for tone reservation comprises:
transmitting a channel state information report comprising the indication, the channel state information report further indicating the one or more other frequency resources.

8. The method of claim 1, further comprising:
transmitting a channel state information report that indicates the one or more other frequency resources, wherein the indication of the selected set of frequency resources for tone reservation is transmitted apart from the channel state information report.

9. The method of claim 1, further comprising:
determining for a frequency resource within the set of candidate frequency resources, based at least in part on the one or more signal quality measurements, a level of interference, an amount of channel fading, a received signal power, an extent of harmonic distortion, or any combination thereof, wherein the selecting is based at least in part on the determining.

10. The method of claim 1, wherein the set of candidate frequency resources comprises a set of resource blocks, and wherein the selected set of frequency resources for tone reservation comprises one or more resource blocks of the set of resource blocks.

11. The method of claim 1, wherein the set of candidate frequency resources comprises a set of resource blocks, and wherein the selected set of frequency resources for tone reservation comprises one or more resource elements of one or more resource blocks of the set of resource blocks.

12. The method of claim 1, wherein the set of candidate frequency resources comprises a resource block, and wherein the selected set of frequency resources for tone reservation comprises one or more resource elements of the resource block.

13. The method of claim 1, wherein the tone reservation is for an algorithm configured to reduce a peak-to-average power ratio (PAPR) associated with the one or more other frequency resources and the selected set of frequency resources.

14. A method for wireless communications at a base station, comprising:
transmitting, to a user equipment (UE), reference signals associated with a set of candidate frequency resources for tone reservation;
receiving, from the UE, an indication of a set of frequency resources for tone reservation, wherein the set of frequency resources for tone reservation are associated with a lower signal quality than one or more other frequency resources within the set of candidate frequency resources; and
transmitting information to the UE via the one or more other frequency resources.

15. The method of claim 14, further comprising:
configuring one or more signals to reduce a peak-to-average power ratio (PAPR) associated with transmitting the information; and
transmitting, based at least in part on the indication, the one or more signals via the indicated set of frequency resources for tone reservation.

16. The method of claim 14, wherein receiving the indication of the set of frequency resources for tone reservation comprises:
receiving a channel state information report comprising the indication, the channel state information report further indicating the one or more other frequency resources.

17. The method of claim 14, further comprising:
receiving a channel state information report that indicates the one or more other frequency resources, wherein the indication of the set of frequency resources for tone reservation is received apart from the channel state information report.

18. The method of claim 14, wherein the set of candidate frequency resources comprises a set of resource blocks, and wherein the set of frequency resources for tone reservation comprises one or more resource blocks of the set of resource blocks.

19. The method of claim 14, wherein the set of candidate frequency resources comprises a set of resource blocks, and wherein the set of frequency resources for tone reservation comprises one or more resource elements of one or more resource blocks of the set of resource blocks.

20. The method of claim 14, wherein the set of candidate frequency resources comprises a resource block, and wherein the set of frequency resources for tone reservation comprises one or more resource elements of the resource block.

21. An apparatus for wireless communications at a user equipment (UE), comprising:
a processor,
memory coupled with the processor; and
instructions stored in the memory and executable by the processor to cause the apparatus to:
receive, from a base station, reference signals associated with a set of candidate frequency resources for tone reservation;
perform one or more signal quality measurements on the reference signals;
select from the set of candidate frequency resources, based at least in part on the one or more signal quality measurements, a set of frequency resources for tone reservation, wherein the selected set of frequency resources for tone reservation are associated with a lower signal quality than one or more other frequency resources within the set of candidate frequency resources;
transmit, to the base station, an indication of the selected set of frequency resources for tone reservation; and
receive, based at least in part on the indication, information from the base station via the one or more other frequency resources.

22. The apparatus of claim 21, wherein the instructions are further executable by the processor to cause the apparatus to:
receive, based at least in part on the indication, one or more signals via the selected set of frequency resources for tone reservation, wherein the one or more signals are configured to reduce a peak-to-average-power-ratio (PAPR) associated with receiving the information.

23. The apparatus of claim 21, wherein the selecting comprises:
select from the set of candidate frequency resources, based at least in part on the one or more signal quality measurements, a first frequency resource having a lowest signal quality, wherein the selected set of frequency resources comprises the first frequency resource.

24. The apparatus of claim 23, wherein the selecting further comprises:
select from the set of candidate frequency resources, based at least in part on the one or more signal quality measurements, one or more additional frequency resources in ascending order of signal quality relative to the first frequency resource until a target quantity of frequency resources are selected, wherein the selected set of frequency resources further comprises the one or more additional frequency resources.

25. The apparatus of claim 21, wherein the selecting comprises:
identify within the set of candidate frequency resources, based at least in part on the one or more signal quality measurements, a group of frequency resources that each satisfy a threshold signal quality; and
select from the group of frequency resources, based at least in part on the one or more signal quality measurements, a first frequency resource having a lowest signal quality, wherein the selected set of frequency resources comprises the first frequency resource.

26. The apparatus of claim 25, wherein the selecting further comprises:
select from the group of frequency resources, based at least in part on the one or more signal quality measurements, one or more additional frequency resources in ascending order of signal quality relative to the first frequency resource until a target quantity of frequency resources are selected, wherein the selected set of frequency resources further comprises the one or more additional frequency resources.

27. The apparatus of claim 21, wherein the instructions to transmit the indication of the selected set of frequency resources for tone reservation are executable by the processor to cause the apparatus to:
transmit a channel state information report comprising the indication, the channel state information report further indicating the one or more other frequency resources.

28. The apparatus of claim 21, wherein the instructions are further executable by the processor to cause the apparatus to:
transmit a channel state information report that indicates the one or more other frequency resources, wherein the indication of the selected set of frequency resources for tone reservation is transmitted apart from the channel state information report.

29. The apparatus of claim 21, wherein the instructions are further executable by the processor to cause the apparatus to:
determine for a frequency resource within the set of candidate frequency resources, based at least in part on the one or more signal quality measurements, a level of interference, an amount of channel fading, a received signal power, an extent of harmonic distortion, or any combination thereof, wherein the selecting is based at least in part on the determining.

30. The apparatus of claim 21, wherein the set of candidate frequency resources comprises a set of resource blocks, and wherein the selected set of frequency resources for tone reservation comprises one or more resource blocks of the set of resource blocks.

31. The apparatus of claim 21, wherein the set of candidate frequency resources comprises a set of resource blocks, and wherein the selected set of frequency resources for tone reservation comprises one or more resource elements of one or more resource blocks of the set of resource blocks.

32. The apparatus of claim 21, wherein the set of candidate frequency resources comprises a resource block, and wherein the selected set of frequency resources for tone reservation comprises one or more resource elements of the resource block.

33. The apparatus of claim 21, wherein the tone reservation is for an algorithm configured to reduce a peak-to-average power ratio (PAPR) associated with the one or more other frequency resources and the selected set of frequency resources.

34. An apparatus for wireless communications at a base station, comprising:
a processor,
memory coupled with the processor; and
instructions stored in the memory and executable by the processor to cause the apparatus to:
transmit, to a user equipment (UE), reference signals associated with a set of candidate frequency resources for tone reservation;
receive, from the UE, an indication of a set of frequency resources for tone reservation, wherein the set of frequency resources for tone reservation are associated with a lower signal quality than one or more other frequency resources within the set of candidate frequency resources; and
transmit information to the UE via the one or more other frequency resources.

35. The apparatus of claim 34, wherein the instructions are further executable by the processor to cause the apparatus to:
configure one or more signals to reduce a peak-to-average power ratio (PAPR) associated with transmitting the information; and
transmit, based at least in part on the indication, the one or more signals via the indicated set of frequency resources for tone reservation.

36. The apparatus of claim 34, wherein the instructions to receive the indication of the set of frequency resources for tone reservation are executable by the processor to cause the apparatus to:
receive a channel state information report comprising the indication, the channel state information report further indicating the one or more other frequency resources.

37. The apparatus of claim 34, wherein the instructions are further executable by the processor to cause the apparatus to:
receive a channel state information report that indicates the one or more other frequency resources, wherein the indication of the set of frequency resources for tone reservation is received apart from the channel state information report.

38. The apparatus of claim 34, wherein the set of candidate frequency resources comprises a set of resource blocks, and wherein the set of frequency resources for tone reservation comprises one or more resource blocks of the set of resource blocks.

39. The apparatus of claim 34, wherein the set of candidate frequency resources comprises a set of resource blocks, and wherein the set of frequency resources for tone reservation comprises one or more resource elements of one or more resource blocks of the set of resource blocks.

40. The apparatus of claim 34, wherein the set of candidate frequency resources comprises a resource block, and wherein the set of frequency resources for tone reservation comprises one or more resource elements of the resource block.

41. An apparatus for wireless communications at a user equipment (UE), comprising:
means for receiving, from a base station, reference signals associated with a set of candidate frequency resources for tone reservation;
means for performing one or more signal quality measurements on the reference signals;
means for selecting from the set of candidate frequency resources, based at least in part on the one or more signal quality measurements, a set of frequency resources for tone reservation, wherein the selected set of frequency resources for tone reservation are associated with a lower signal quality than one or more other frequency resources within the set of candidate frequency resources;
means for transmitting, to the base station, an indication of the selected set of frequency resources for tone reservation; and
means for receiving, based at least in part on the indication, information from the base station via the one or more other frequency resources.

42. An apparatus for wireless communications at a base station, comprising:
means for transmitting, to a user equipment (UE), reference signals associated with a set of candidate frequency resources for tone reservation;
means for receiving, from the UE, an indication of a set of frequency resources for tone reservation, wherein the set of frequency resources for tone reservation are associated with a lower signal quality than one or more other frequency resources within the set of candidate frequency resources; and
means for transmitting information to the UE via the one or more other frequency resources.

43. A non-transitory computer-readable medium storing code for wireless communications at a user equipment (UE), the code comprising instructions executable by a processor to:
receive, from a base station, reference signals associated with a set of candidate frequency resources for tone reservation;
perform one or more signal quality measurements on the reference signals;
select from the set of candidate frequency resources, based at least in part on the one or more signal quality measurements, a set of frequency resources for tone reservation, wherein the selected set of frequency resources for tone reservation are associated with a lower signal quality than one or more other frequency resources within the set of candidate frequency resources;
transmit, to the base station, an indication of the selected set of frequency resources for tone reservation; and
receive, based at least in part on the indication, information from the base station via the one or more other frequency resources.

44. A non-transitory computer-readable medium storing code for wireless communications at a base station, the code comprising instructions executable by a processor to:
transmit, to a user equipment (UE), reference signals associated with a set of candidate frequency resources for tone reservation;
receive, from the UE, an indication of a set of frequency resources for tone reservation, wherein the set of frequency resources for tone reservation are associated with a lower signal quality than one or more other frequency resources within the set of candidate frequency resources; and
transmit information to the UE via the one or more other frequency resources.
